(19) United States
(12) Patent Application Publication
(10) Pub. No.: US 2014/0216938 A1
(43) Pub. Date: Aug. 7, 2014

(54) MICRO-CHEMICAL MIXING

(71) Applicant: Alcatel Lucent, Paris (FR)

(72) Inventors: Joanna Aizenberg, New Providence, NJ (US); Paul Robert Kolodner, Hoboken, NJ (US); Thomas Nikita Krupenkin, Warren, NJ (US)

(73) Assignee: Alcatel Lucent, Paris (FR)

(21) Appl. No.: 14/247,791

(22) Filed: Apr. 8, 2014

Related U.S. Application Data
(62) Division of application No. 11/319,865, filed on Dec. 27, 2005, now Pat. No. 8,734,003.
Application No. 11/319,865 is a continuation-in-part of application No. 11/227,759, filed on Sep. 15, 2005, now Pat. No. 8,721,161.

(51) Int. Cl. B01F 13/00; B01L 3/02

(52) U.S. Cl. CPC B01F 13/0071; B01L 3/0241
USPC 204/600

(57) ABSTRACT

A device comprising, a substrate having a droplet thereover, and an electrical source coupleable to the substrate. The electrical source is configured to apply a voltage between the substrate and the droplet using an electrode. The electrode has a first portion and a second portion non-symmetric to the first portion, the first and second portions defined by a plane located normal to a longitudinal axis and through a midpoint of a length of the electrode.

### CROSS-REFERENCE TO RELATED APPLICATIONS

This Application is a Divisional of U.S. application Ser. No. 11/319,865 which was filed on Dec. 27, 2005, to Aizenberg, et al, entitled “MICRO-CHEMICAL MIXING,” currently allowed, which in turn is a Continuation-in-Part of U.S. application Ser. No. 11/227,759 filed on Sep. 15, 2005, to Joanna Aizenberg, et al., entitled “FLUID OSCILLATIONS ON STRUCTURED SURFACES,” also currently allowed, all of which are commonly assigned with the present invention, and fully incorporated herein by their entirety by reference.

### TECHNICAL FIELD OF THE INVENTION

The present invention is directed, in general, to a device and a method for mixing two or more species within a droplet.

### BACKGROUND OF THE INVENTION

One problem encountered when handling small fluid volumes is to effectively mix different fluids together. For instance, poor mixing can occur in droplet-based microfluidic devices, where the fluids are not confined in channels. In droplet based systems, small droplets of fluid (e.g., fluid volumes of about 100 microliters or less) are moved and mixed together on a surface. In some cases, it is desirable to add a small volume of a reactant to a sample droplet to facilitate the analysis of the sample, without substantially diluting it. In such cases, there is limited ability to mix the two fluids together because there is no movement of the fluids to facilitate mixing.

Embodiments of the present invention overcome these problems by providing a device and method that facilitates the movement and mixing of small volumes of fluids.

### SUMMARY OF THE INVENTION

To address the above-discussed deficiencies of the prior art, the present invention provides a device. The device, without limitation, includes a substrate having a droplet thereover, and an electrical source coupleable to the substrate, the electrical source configured to apply a voltage between the substrate and the droplet using an electrode, wherein the electrode has a first portion and a second portion non-symmetric to the first portion, the first and second portions defined by a plane located normal to a longitudinal axis and through a midpoint of a length of the electrode.

### BRIEF DESCRIPTION OF THE DRAWINGS

The invention is best understood from the following detailed description when read with the accompanying FIGUREs. It is emphasized that, in accordance with the standard practice in the semiconductor industry, various features are not drawn to scale. In fact, the dimensions of the various features may be arbitrarily increased or reduced for clarity of discussion. Reference is now made to the following descriptions taken in conjunction with the accompanying drawings, in which:

FIGS. 1A thru 1E illustrate cross-sectional views of a device while undergoing a process for mixing two or more species within a droplet in accordance with the principles of the present invention;

FIGS. 2A thru 2D illustrate different objects, in this embodiment electrodes, that might be used in place of the object illustrated in FIGS. 1A thru 1E;

FIG. 3 illustrates an alternative embodiment of an object that might be used with the methodology discussed above with respect to FIGS. 1A thru 1E;

FIG. 4 illustrates a cross-sectional view of an alternative embodiment of a device while undergoing a process for mixing two or more species within a droplet in accordance with the principles of the present invention;

FIG. 5 illustrates an alternative embodiment of a device in accordance with the principles of the present invention;

FIG. 6 illustrates a cross-sectional view of an alternative embodiment of a device while undergoing a process for mixing two or more species within a droplet in accordance with the principles of the present invention; and

FIG. 7 illustrates one embodiment of a mobile diagnostic device in accordance with the principles of the present invention.

### DETAILED DESCRIPTION

The present invention recognizes that the vertical position of a droplet (e.g., a droplet of fluid) can be made to oscillate on certain kinds of substrates. In certain embodiments, the vertical position of the droplet can be made to oscillate on a conductive substrate having fluid-support-structures thereon. The application of a voltage between the substrate and the droplet may cause the droplet to alternate between a state with a high contact angle (e.g., a less flattened configuration or a non-wetted state) and a state with a lower contact angle (e.g., a more flattened configuration or a wetted state). In such embodiments the substrate comprises a pattern of fluid-support-microstructures, the applied voltage causing a surface of the droplet to move between tops of the fluid-support-microstructures and the substrate on which the microstructures are located. Such movements cause the droplet to move between effective more flattened and less flattened states, respectively.

As part of the present invention, it was further discovered that repeatedly deforming (e.g., oscillating) the droplet in this manner promotes mixing of two or more species (e.g., chemical species) within the droplet. For instance, the repeated deformation of the droplet can induce motion within the droplet, thereby promoting mixing of the two or more species of fluids. Without being limited to such, it is believed that the movement of the droplet with respect to an object located therein promotes the mixing, the object may for example be an electrode used to provide the voltage.

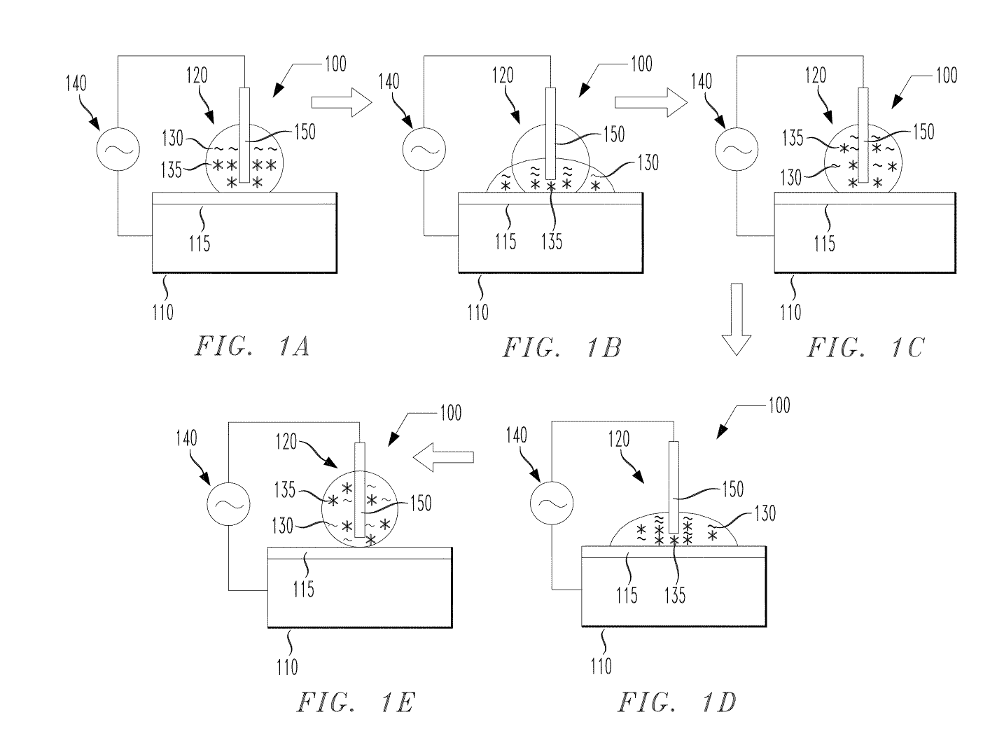

Turning now to FIGS. 1A thru 1E illustrated are cross-sectional views of a device 100 while a droplet undergoes a process for mixing two or more species therein in accordance with the principles of the present invention. The device 100 of FIGS. 1A thru 1E initially includes a substrate 110. The substrate 110 may be any layer located within a device and having properties consistent with the principles of the present invention. For instance, in one exemplary embodiment of the present invention the substrate 110 is a conductive substrate.

Some preferred embodiments of the conductive substrate 110 comprise silicon, metal silicide, or both. In some preferred embodiments, for example, the conductive substrate 110 comprises a metal silicide such as cobalt silicide. However, other metal silicides, such as tungsten silicide or nickel silicide, or alloys thereof, or other electrically conductive materials, such as metal films, can be used.

In the embodiment wherein the substrate 110 is a conductive substrate, an insulator layer 115 may be disposed thereon. Those skilled in the art understand the materials that could comprise the insulator layer 115 while staying within the scope of the present invention. It should also be noted that in various embodiments of the present invention, one or both of the substrate 110 or insulator layer 115 has hydrophobic properties. For example, one or both of the substrate 110 or insulator layer 115 might at least partially comprise a low-surface-energy material. For the purposes of the present invention, a low-surface-energy material refers to a material having a surface energy of about 22 dyne/cm (about 22×10⁻⁵ N/cm) or less. Those of ordinary skill in the art would be familiar with the methods to measure the surface energy of such a material. In some preferred embodiments, the low-surface-energy material comprises a fluorinated polymer, such as polytetrafluoroethylene, and has a surface energy ranging from about 18 to about 20 dyne/cm.

Located over the substrate 110 in the embodiment shown, and the insulator layer 115 if present, is a droplet 120. The droplet 120 may comprise a variety of different species and fluid volumes while staying within the scope of the present invention. In one exemplary embodiment of the present invention, however, the droplet 120 has a fluid volume of about 100 microliters or less. It has been observed that the methodology of the present invention is particularly useful for mixing different species located within droplets 120 having fluid volumes of about 100 microliters or less. Nevertheless, the present invention should not be limited to any specific fluid volume.

Located within the droplet 120 in the embodiments of FIGS. 1A thru 1E are a first species 130 and a second species 135. For the purpose of illustration, the first species 130 is denoted as (˜) and the second species is denoted as (*). The first species 130 may be a diluent or a reactant. Similarly, the second species 135 may be a diluent or a reactant. In the exemplary embodiment shown, however, the first species 130 is a first reactant and the second species 135 is a second reactant, both of which are suspended within a third species, such as a diluent.

Some preferred embodiments of the device 100 also comprise an electrical source 140 (e.g., an AC or DC voltage source) coupled to the substrate 110 and configured to apply a voltage between the substrate 110 and the droplet 120 located thereover. In the illustrative embodiment of FIGS. 1A thru 1E, the electrical source 140 uses an object 150, such as an electrode, to apply the voltage. While the embodiment of FIGS. 1A thru 1E illustrates that the object 150 is located above the substrate 110, other embodiments exist wherein the object 150 contacts the droplet 120 from another location, such as from below the droplet 120. Those skilled in the art understand how to configure such an alternative embodiment. Moreover, as will be discussed more fully below, the object 150 may take on a number of different configurations and remain within the purview of the present invention.

Given the device 100 illustrated in FIGS. 1A thru 1E, the first species 130 and the second species 135 may be at least partially mixed within the droplet 120 using the inventive aspects of the present invention. Turning initially to FIG. 1A, the droplet is positioned in its less flattened state. For instance, because substantially no voltage is applied between the substrate 110 and the droplet 120, the droplet is in its natural configuration. It should be noted that the first species 130 and the second species 135 located within the droplet of FIG. 1A are substantially, if not completely, separated from one another.

Turning now to FIG. 1B, illustrated is the device 100 of FIG. 1A, after applying a non-zero voltage between the substrate 110 and the droplet 120 using the electrical source 140 and the object 150. As would be expected, the droplet 120 moves to a flattened state, and thus is in its deformed configuration. It is the movement of the object 150 within the droplet 120 that is believed to promote the mixing of the first species 130 and the second species 135. It should be noted, however, that other phenomena might be responsible for at least a portion of the mixing.

In some cases, the electrical source 140 is configured to apply a voltage ranging from about 1 to about 50 Volts. It is sometimes desirable for the voltage to be applied as a brief pulse so that the droplet 120 after becoming flattened can bounce back up to its less flattened state. In some cases, the applied voltage is a series of voltage pulses applied at a rate in the range from about 1 to 100 Hertz, and more preferably from about 10 to 30 Hertz. In other cases, the applied voltage is an AC voltage. In some preferred embodiments, the AC voltage has a frequency in the range from about 1 to about 100 Hertz. One cycle of droplet oscillation is defined to occur when the droplet 120 makes a round-trip change from the less flattened state to the more flattened state and back up to the less flattened state, or from the more flattened state to the less flattened state and back down to the more flattened state. Take notice how the first species 130 and the second species 135 in the embodiment of FIG. 1B are slightly more mixed within the droplet 120 than the first species 130 and second species 135 in the droplet 120 of FIG. 1A.

Turning now to FIG. 1C, illustrated is the device 100 of FIG. 1B after removing the voltage being applied via the electrical source 140 and object 150. Thus, the droplet 120 substantially returns to its less flattened state, and has therefore made one complete cycle of movement. As one would expect based upon the disclosures herein, the movement from the more flattened state of FIG. 1B to the less flattened state of FIG. 1C may promote additional mixing. Accordingly, the first species 130 and second species 135 may be more mixed in the droplet 120 of FIG. 1C than the droplet 120 of FIG. 1B.

Moving on to FIGS. 1D and 1E, the droplet 120 undergoes another cycle of movement, thus further promoting the mixing of the first species 130 and second species 135 therein. In accordance with the principles of the present invention, the droplet 120 may repeatedly be deformed, until a desired amount of mixing between the first species 130 and the second species 135 has occurred. The number of cycles, and thus the amount of mixing between the first species 130 and the second species 135, may be based upon one or both of a predetermined number of cycles or a predetermined amount of time. In any event, addition mixing typically occurs with each cycle, at least until the first species 130 and second species 135 are completely mixed.

Uniquely, the present invention uses the repeated deformation of the droplet 120 having the object 150 therein to accomplish mixing of the first species 130 and second species 135 within the droplet 120. Accordingly, wherein most methods for mixing the species within the droplet would be based upon the relative movement of the object 150 with respect to the droplet 120, the present invention is based upon the movement of the droplet 120 with respect to the object 150. For instance, in most preferred embodiments the object 150 is fixed, and thus stationary, and it is the movement of the droplet 120 using the electrical source 140 that promotes the movement.

This being said, the method disclosed herein provides what is believed to be unparalleled mixing for two or more species within a droplet. Namely, the method disclosed herein in capable of easily mixing two or more species that might be located within a droplet having a fluid volume of about 100 microliters or less. Prior to this method, easy mixing of such small volumes was difficult, at best.

In various embodiments, the object 150 is positioned asymmetric along the axis of motion of the droplet being physically distorted. For example, the object 150 may be positioned a non-zero angle away from the direction of movement of the droplet during mixing. This non-zero angle might be used to introduce increased mixing.

The embodiments of FIGS. 1A thru 1E are droplet based micro fluidic system. It should be noted, however, that other embodiments might consist of micro channel based micro fluidic systems, wherein the droplet might be located within a channel and the mixing occurring within one or more channels, as opposed to that shown in FIGS. 1A thru 1E. Those skilled in the art understand just how the inventive aspects of the present invention could be employed with such a micro channel based micro fluidic system.

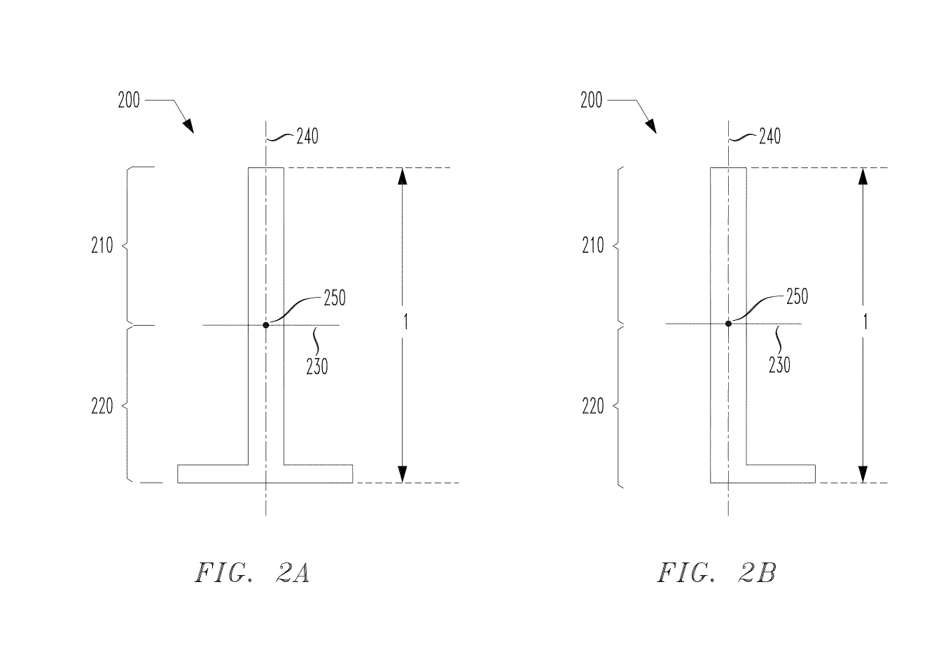

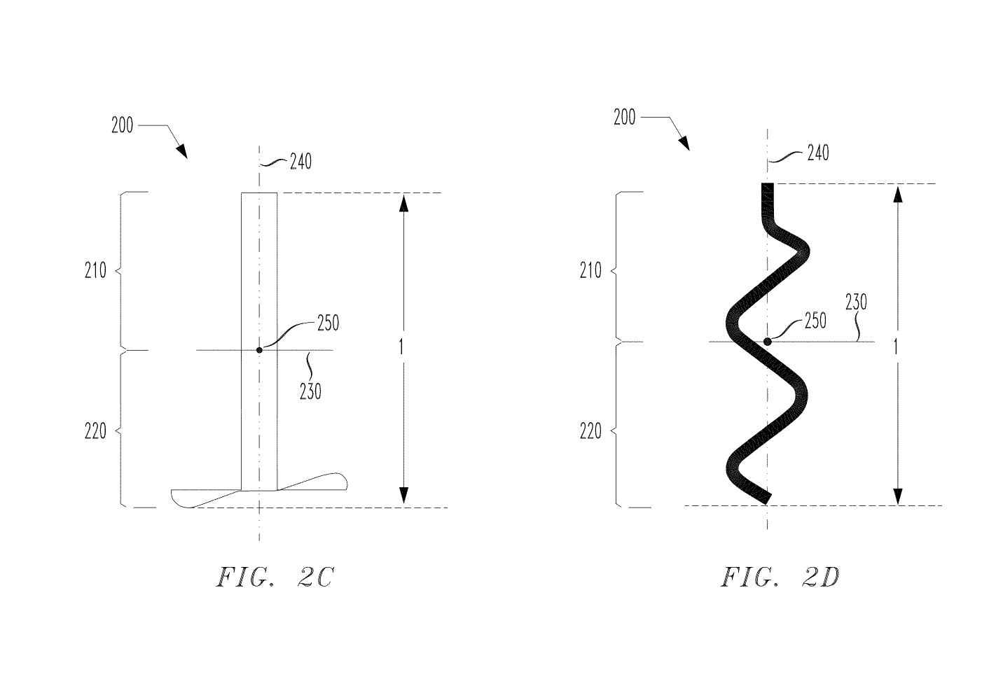

Turning now to FIGS. 2A thru 2D, illustrated are different objects 200, in this embodiment electrodes, that might be used in place of the object 150 illustrated in FIGS. 1A thru 1E. Specifically, the objects 200 illustrated in FIGS. 2A thru 2D each have a first portion 210 and a second portion 220 non-symmetric to the first portion 210. In these embodiments, the first and second portions 210, 220, are defined by a plane 230 located normal to a longitudinal axis 240 and through a midpoint 250 of a length (l) of the object 200. As is illustrated in FIGS. 2A thru 2D, the first portion 210 located above the plane 230 is non-symmetric to the second portion 220 located below the plane 230.

To accomplish the aforementioned non-symmetric nature of the object 200, the object 200 may take on many different shapes. For example, the object 200 of FIG. 2A comprises an inverted T, or depending on the view, a disk disposed along a shaft. Alternatively, the object 200 of FIG. 2B comprises an L, the object 200 of FIG. 2C comprises a propeller and the object 200 of FIG. 2D comprises a helix. Each of the different shapes of FIGS. 2A thru 2D provide increased mixing when the droplet moves with respect to the object as discussed with respect to FIGS. 1A thru 1E above, at least as compared to the symmetric object 150 illustrated in FIGS. 1A thru 1E. For instance, what might take a first species about 10 minutes to mix with a second species using only simple diffusion, might only take about 1 minute using the object 150 illustrated in FIGS. 1A thru 1E, and further might only take about 15 seconds using an object similar to the object 200 illustrated in FIG. 2D. Thus, the object 150 of FIGS. 1A thru 1E might provide about 10 times the mixing as compared to passive diffusion, whereas the objects 200 of FIGS. 2A thru 2D might provide about 30 times the mixing as compared to passive diffusion. Obviously, the aforementioned improvements are representative only, and thus should not be used to limit the scope of the present invention.

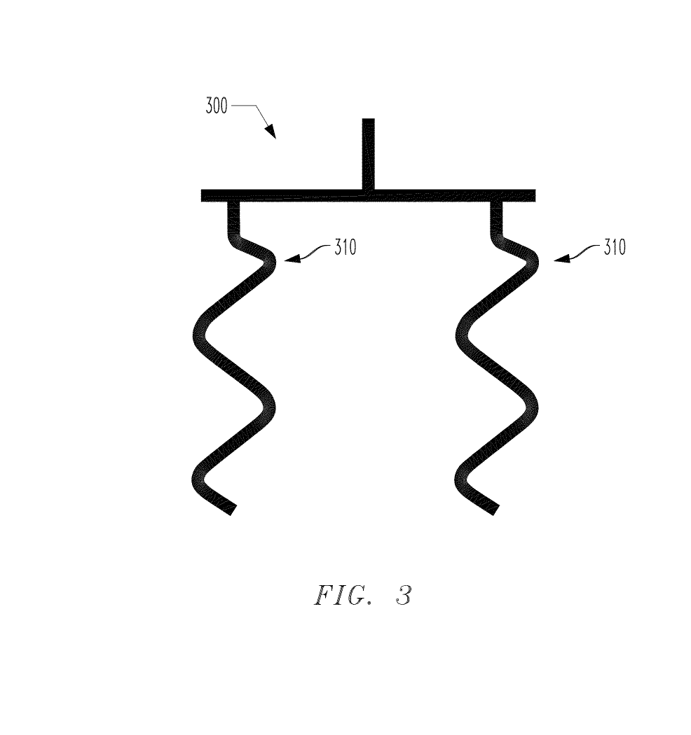

Turning briefly to FIG. 3, illustrated is an alternative embodiment of an object 300 that might be used with the methodology discussed above with respect to FIGS. 1A thru 1E. The object 300 of FIG. 3, as compared to the objects 150, 200 of FIGS. 1A thru 1E and 2A thru 2D, respectively, comprises multiple vertical sections 310. The vertical sections 310 attempt to create a swirling effect within the droplet, thereby providing superior mixing of the two or more species. While each of the vertical sections 310 illustrated in FIG. 3 are shown as helix structures, similar to the object 200 of FIG. 2D, other embodiments exist wherein each of the vertical sections 310 are similar to any one of the shapes illustrated in previous FIGUREs, as well as other shapes neither disclosed nor shown.

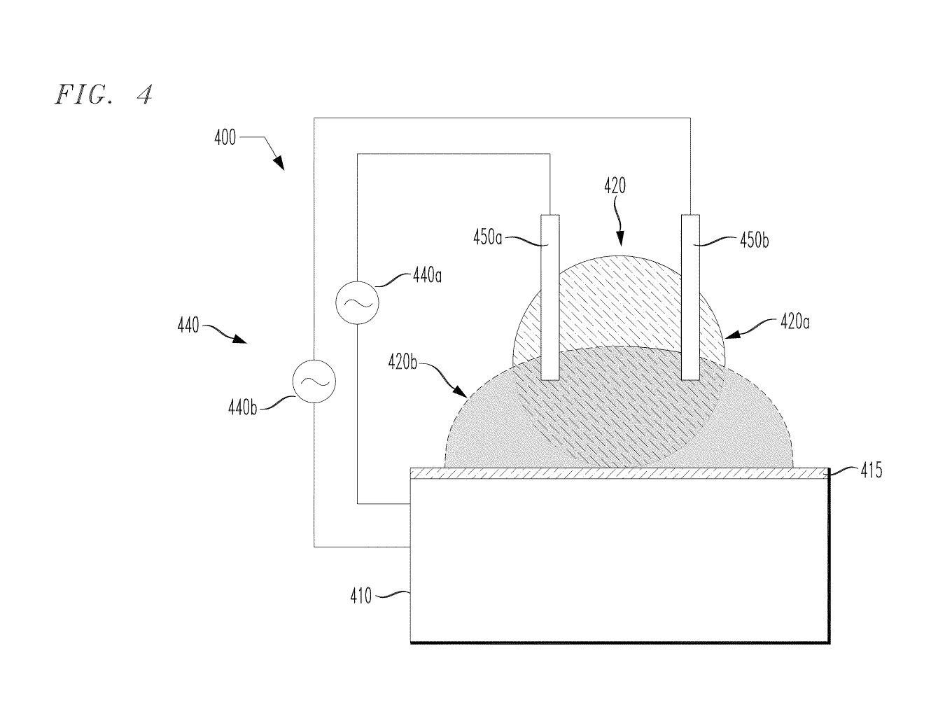

Turning now to FIG. 4, illustrated is a cross-sectional view of an alternative embodiment of a device 400 while undergoing a process for mixing two or more species within a droplet in accordance with the principles of the present invention. The device 400 of FIG. 4 is substantially similar to the device 100 illustrated in FIGS. 1A thru 1E, with the exception that multiple objects 450a and 450b are positioned at different locations within the droplet 420. In an exemplary embodiment, each one of the multiple objects 450a and 450b is an individually addressable electrode. For instance, each one of the multiple objects 450a and 450b may be connected to different electrical sources 440a and 440b, respectively, thereby providing the ability to address them individually. In an alternative embodiment, each one of the multiple objects 450a and 450b could be connected to the same electrical source 440, whether it be a fixed or variable electrical source, and switches could be placed between the electrical source 440 and each one of the multiple objects 450a and 450b. Thus, the switches would allow for the ability to address each one of the multiple objects 450a and 450b individually.

The device 400 of FIG. 4 might be operated by alternately applying a voltage between the multiple objects 450a and 450b. In such an operation, an additional in-plane oscillation of the droplet 420 between the multiple objects 450a and 450b might occur. Accordingly, wherein the device 100 of FIGS. 1A thru 1E might only cause the droplet 120 to move normal to the surface on which it rests, the device 400 of FIG. 4 might cause the droplet 420 to have this additional in-plane movement (e.g., along the surface on which it rests). As those skilled in the art appreciate, this additional in-plane movement may induce increased mixing, at least as compared to the movement created in the droplet 120 of FIGS. 1A thru 1E.

As an extension of this point, those skilled in the art could design certain more complex geometries, with numerous addressable objects, to ensure rigorous mixing due to the induced movement of the droplet in the different directions. For example, such rigorous mixing might be induced using a device having its objects positioned as follows:

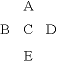

By using the combination of these five independent objects (e.g., electrodes A, B, C, D and E) one can either induce normal up and down movement of the droplet by applying a voltage to object C (such as is illustrated with respect to FIGS. 1A thru 1E), induce an in-plane movement of the droplet by applying an alternating voltage between objects A and E or B and D (such as is illustrated with respect to FIG. 4 above), or induce a spinning movement of the droplet by sequentially applying a voltage to objects A, B, E and D. Obviously, other complex geometries might provide even more significant mixing.

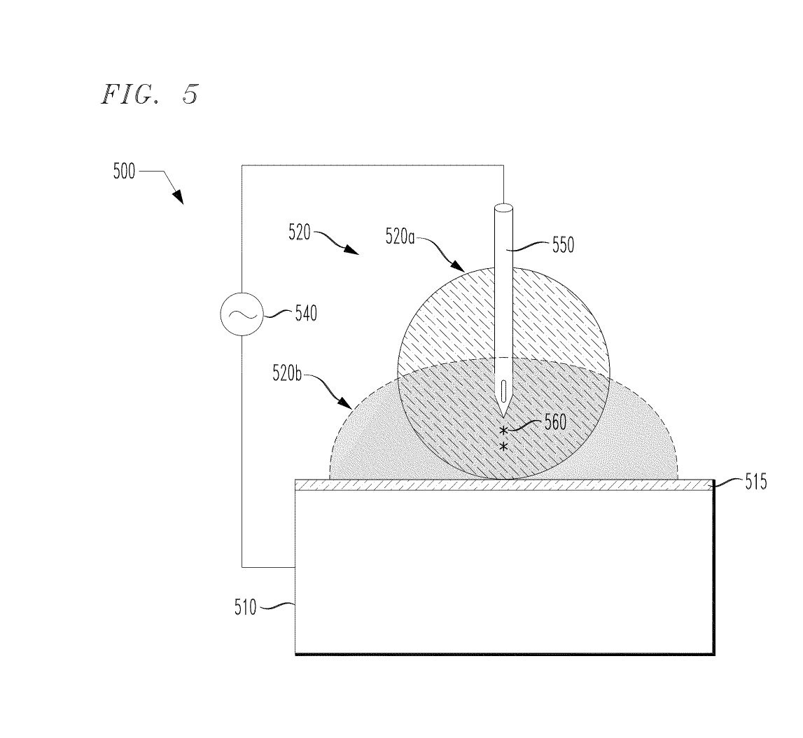

Turning now to FIG. 5, illustrated is an alternative embodiment of a device 500 in accordance with the principles of the present invention. The embodiment of the device 500 includes a substrate 510, an insulator layer 515, a droplet 520 (in both a less flattened state 520a and a more flattened state 520b), an electrical source 540 and an object 550. In this embodiment, the object 550 is both configured to act as a hollow needle, and thus is configured to supply one or more species 560 to the droplet 520, and well as configured to apply a voltage across the droplet 520. Thus, in the embodiment shown, the object 550 is an electrode also configured as a hollow needle, or vice-versa.

Those skilled in the art understand the many different shapes for the object 550 that might allow the object 550 to function as both the electrode and the needle. For that matter, in addition to a standard needle shape, each of the shapes illustrated in FIGS. 2A thru 2D could be configured as a needle, thus providing both functions. Other shapes could also provide both functions and remain within the purview of the present invention.

It should also be noted that rather than the object 550 being configured as a single needle having a single fluid channel to provide a species 560, the object 550 could comprise a plurality of fluid channels to provide a plurality of different species 560 to the droplet 520. For example, in one embodiment, the object 550 comprises a cluster of different needles, each different needle having its own fluid channel configured to provide a different species 560. In another embodiment, however, the object 550 comprises a single needle, however the single needle has a plurality of different fluid channels for providing the different species 560. Other configurations, which are not disclosed herein for brevity, could nevertheless also be used to introduce different species 560 within the droplet 520. The above-discussed embodiments are particularly useful wherein there is a desire to keep the different species separate from one another, such as wherein the two species might undesirably react with one another.

The device 500 including the object 550 may, therefore, be used to include any one or a collection of species 560 within the droplet 520. The object 550 may, in addition to the ability to provide one or more species 560 within the droplet 520, also function as an electrode to move the droplet 520 using electrowetting, mix two or more species within the droplet 520 using the process discussed above with respect to FIGS. 1A thru 1E, or any other known or hereafter discovered process.

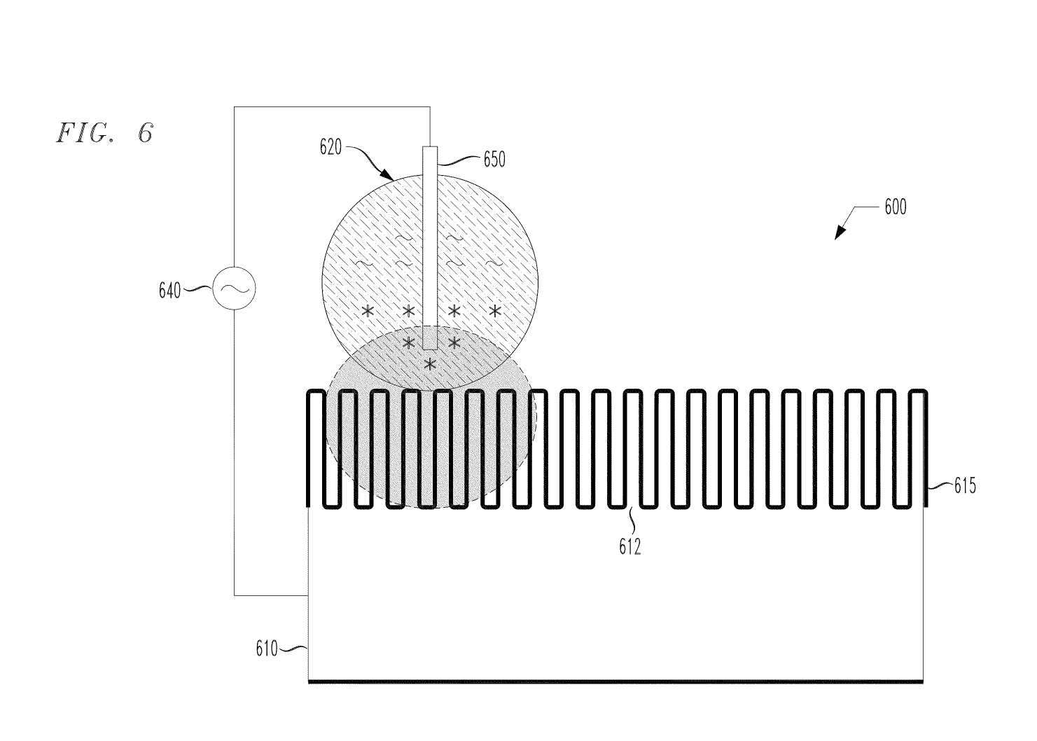

Turning now to FIG. 6, illustrated is a cross-sectional view of an alternative embodiment of a device 600 while undergoing a process for mixing two or more species within a droplet in accordance with the principles of the present invention. The device 600 of FIG. 6 initially includes a substrate 610. The device 600 also includes fluid-support-structures 612 that are located over the substrate 610. Each of the fluid-support-structures 612, at least in the embodiment shown, has at least one dimension of about 1 millimeter or less, and in some cases, about 1 micron or less. As those skilled in the art appreciate, the fluid-support-structures 612 may comprise microstructures, nanostructures, or both microstructure and nanostructures.

In some instances, the fluid-support-structures 612 are laterally separated from each other. For example, the fluid-support-structures 612 depicted in FIG. 6 are post-shaped, and more specifically, cylindrically shaped posts. The term post, as used herein, includes any structures having round, square, rectangular or other cross-sectional shapes. In some embodiments of the device 600, the fluid-support-structures 612 form a uniformly spaced array. However, in other cases, the spacing is non-uniform. For instance, in some cases, it is desirable to progressively decrease the spacing between fluid-support-structures 612. For example, the spacing can be progressively decreased from about 10 microns to about 1 micron in a dimension.

In the embodiment shown, the fluid-support-structures 612 are electrically coupled to the substrate 610. Moreover, each fluid-support-structure 612 is coated with an electrical insulator 615. One suitable insulator material for the electrical insulator 615 is silicon dioxide.

Exemplary fluid-support micro-structures and patterns thereof are described in U.S. Patent Application Publs.: 20050039661 of Avinoam Kornblit et al. (publ'd Feb. 24, 2005), U.S. Patent Application Publ. 20040191127 of Avinoam Kornblit et al. (publ'd Sep. 30, 2004), and U.S. Patent Application Publ. 20050069458 of Marc S. Hodes et al. (publ'd Mar. 31, 2005). The above three published U.S. Patent Applications are incorporated herein in their entirety.

The device 600 of FIG. 6 further includes a droplet 620 located over the substrate 610 and the fluid-support-structures 612. In the embodiment shown, the droplet 620 is resting on a top surface of the fluid-support-structures 612. The device 600 may further include an electrical source 640 and an object 650. The substrate 610, electrical insulator 615, droplet 620, electrical source 640 and object 650 may be similar to their respective features discussed above with regard to previous FIGUREs.

As those skilled in the art would expect, at least based upon the aforementioned discussions with respect to FIGS. 1A thru 1E, FIGS. 2A thru 2D, and FIGS. 3, 4 and 5, the device 600 may be configured to oscillate the droplet 620 between the tops of the fluid-support-structures 612 and the substrate 610, when a voltage is applied between the substrate 610 and the droplet 620 using the electrical source 640 and the object 650. For example, the device 600 can be configured to move the droplet 620 vertically, such that a lower surface of the droplet 620 moves back and forth between the tops of the fluid-support-structures 612 and the substrate 610 in a repetitive manner.

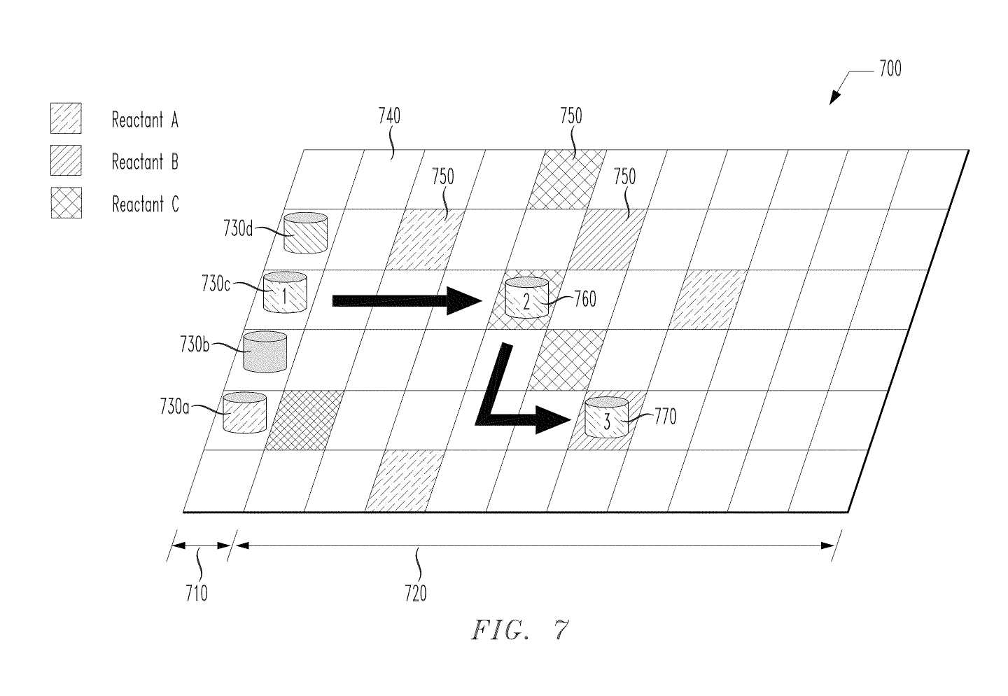

Based upon all of the foregoing, it should be noted that the present invention, and all of the embodiments thereof, might be used with, among others, a mobile diagnostic device such as a lab-on-chip or microfluidic device. Turning briefly to FIG. 7, illustrated is one embodiment of a mobile diagnostic device 700 in accordance with the principles of the present invention. The mobile diagnostic device 700 illustrated in FIG. 7 initially includes a sample source region 710 and a chemical analysis region 720. As is illustrated in FIG. 7, the sample source region 710 may include a plurality of droplets 730, in this instance four droplets 730a, 730b, 730c, and 730d. As is also illustrated in FIG. 7, the chemical analysis region 720 may include a plurality of both blank pixels 740 and reactant pixels 750.

The device 700 of FIG. 7, as shown, may operate by moving the droplets 730 across the chemical analysis region 720, for example using electrowetting. As the droplets 730 encounter a reactant pixel 750, a voltage may be applied across the substrate and the droplet 730, thereby causing the droplet 730 to move to a more flattened state (e.g., wetted state in certain embodiments), and thus come into contact with the reactant located within that particular reactant pixel. The reactant in the pixel may be of a liquid form or a solid form. For example, the reactant may be in a solid form, and thus dissolved or adsorbed by the droplet 730.

This process is illustrated using the droplet 730c. For example, the droplet 730c is initially located at a position 1. Thereafter, the droplet 730c is moved laterally using any known or hereafter discovered process wherein it undergoes an induced reaction 760 at position 2. The induced reaction 760, in this embodiment, is initiated by applying a non-zero voltage between the substrate and the droplet 730c, thereby causing the droplet 730c to move to a more flattened state, and thus come into contact with the reactant in that pixel. Thereafter, as shown, the droplet 730c could be moved to a position 3, wherein it undergoes another induced reaction 770.

It should be noted that while the droplets 730 are located at any particular location, the droplets 730 may be repeatedly deformed in accordance with the principles discussed above with respect to FIGS. 1A thru 1E. Accordingly, the reactant acquired during the induced reactions 760, 770, may be easily mixed using the process originally discussed above with respect to FIGS. 1A thru 1E.

In certain embodiments, each of the droplets 730 has its own object, and thus the droplets can be independently repeatedly deformed. In these embodiments, each of the objects could be coupled to an independent AC voltage supply, or alternatively to the same AC voltage supply, to induce the mixing. Each of the mentioned objects could also be configured as a needle, and thus provide additional reactant species to the drops, such as discussed above with respect to FIG. 5. Those skilled in the art understand the other ideas that might be used with the device 700.

Although the present invention has been described in detail, those skilled in the art should understand that they could make various changes, substitutions and alterations herein without departing from the spirit and scope of the invention in its broadest form.

What is claimed is:

1. A device, comprising:
a substrate having a droplet thereover;
an electrical source coupleable to the substrate, the electrical source configured to apply a voltage between the substrate and the droplet using an electrode, wherein the electrode source has a first portion and a second portion non-symmetric to the first portion, the first and second portions defined by a plane located normal to a longitudinal axis and through a midpoint of a length of the electrode source.

2. The device as recited in claim 1, wherein the electrode source is shaped as a helix.

3. The device as recited in claim 1, wherein a shape of the electrode source is shaped as an inverted T.

4. The device as recited in claim 1, wherein a shape of the electrode source is shaped as an L.

5. The device as recited in claim 1, wherein a shape of the electrode source is shaped as a disk disposed along a shaft.

6. The device as recited in claim 1, wherein a shape of the electrode source is shaped as a propeller.

7. The device as recited in claim 1, wherein the electrode source is shaped as a needle, the needle configured to provide a chemical species within the droplet.

8. The device as recited in claim 8, wherein the chemical species was not previously within the droplet.

9. The device as recited in claim 1, wherein the droplet includes a first chemical species, a second different chemical species is located on the substrate, and, the first chemical species and the second chemical species has a concentration gradient with respect to each other.

10. The device as recited in claim 1, wherein the substrate further includes a fluid-support-structure having at least one dimension of about 1 millimeter or less, and wherein applying a voltage causes the droplet to move between a top of the fluid-support-structure and a base of the fluid-support-structure.

11. The device as recited in claim 1, wherein the substrate and an electrical source are part of a lab-on-a-chip.
